(19) United States
(12) Patent Application Publication
(10) Pub. No.: US 2021/0278097 A1
(43) Pub. Date: Sep. 9, 2021

(54) AIR CLEANER

(71) Applicant: LG ELECTRONICS INC., Seoul (KR)

(72) Inventors: Junho MIN, Seoul (KR); Taeman Yang, Seoul (KR); Joonmin Park, Seoul (KR); Choonmyun Chung, Seoul (KR)

(21) Appl. No.: 17/189,736

(22) Filed: Mar. 2, 2021

(30) Foreign Application Priority Data
Mar. 5, 2020 (KR) 10-2020-0027923

(51) Int. Cl. F24F 8/80; F24F 8/108; F24F 13/20

(52) U.S. Cl. CPC F24F 8/80; F24F 2013/205; F24F 13/20; F24F 8/108

(57) ABSTRACT

The present disclosure related to an air purifier. The air purifier of the present disclosure includes: a case having a cylindrical shape and having a plurality of air suction ports formed in a circumferential wall; a filter disposed inside the case and filtering foreign matter in an air introduced through the air suction port; a fan disposed above the filter and flowing the air introduced through the air suction port in an upward direction; a fan housing disposed above the filter and forming a fan space in which the fan is disposed; a fan motor disposed above the fan and rotating the fan; and a cover protruding from the fan housing into the fan space so as to be disposed outside the fan, wherein a lower end of the fan is disposed by a certain distance from a lower wall of the fan housing to an upper wall, and the cover protrudes above the lower end of the fan from the lower wall of the fan housing.

### CROSS-REFERENCE TO RELATED APPLICATION(S)

This application claims priority to and the benefit of Korean Patent Application No. 10-2020-0027923, filed in Korea on Mar. 5, 2020, the disclosure of which is incorporated herein by reference in its entirety.

### BACKGROUND OF THE INVENTION

### 1. Field of the Invention

The present disclosure relates to an air cleaner.

### 2. Description of the Related Art

An air purifier is understood as an apparatus that sucks and purifies contaminated air, and then discharges the purified air. For example, the air purifier may include a blower for introducing external air into the air purifier, and a filter for filtering dust or bacteria in the air.

In general, an air purifier is configured to purify an indoor space such as a home or an office. In order to purify the air in the indoor space in a short time, it is necessary to increase the amount of air discharged from the air purifier.

Korean Patent Publication No. KR10-2017-0140578 discloses an air purifier having a structure that discharges air upward from a 360-degree direction. Air may flow upward according to the rotation of a blowing fan disposed inside a case. However, when the air flowing by the blowing fan backflows into a space formed between a fan and a fan housing disposed below the fan, there is a problem in that the amount of air flow may be reduced.

### SUMMARY OF THE INVENTION

The present disclosure has been made in view of the above problems, and provides an air purifier that maximizes the amount of air blown from the air purifier.

In accordance with an aspect of the present disclosure, an air purifier includes: a case having a cylindrical shape and having a plurality of air suction ports formed in a circumferential wall; a filter disposed inside the case and filtering foreign matter in an air introduced through the air suction port; a fan disposed above the filter and flowing the air introduced through the air suction port in an upward direction; a fan housing disposed above the filter and forming a fan space in which the fan is disposed; a fan motor disposed above the fan and rotating the fan; and a cover protruding from the fan housing into the fan space so as to be disposed outside the fan, wherein a lower end of the fan is disposed by a certain distance from a lower wall of the fan housing to an upper wall, and the cover protrudes above the lower end of the fan from the lower wall of the fan housing. Accordingly, the cover can prevent the backflow of air generated into a distance formed between the fan and the fan housing.

The fan housing includes a fan inlet that is bent to the inside of the fan and extends upward, wherein a height of the cover protruding upward from the lower wall is higher than a height of the fan inlet protruding upward from the lower wall, thereby suppressing the backflow of air.

The fan housing includes a circumferential wall forming a space in which the fan is accommodated; a lower wall bent at a lower end of the circumferential wall and extending in a direction of a rotational center of the fan; and a fan inlet upwardly bent at an inner end of the lower wall and extending, wherein the cover is spaced radially outward from the fan inlet and is formed to protrude upward from the lower wall.

The lower end of the fan is disposed between the cover and the fan inlet, thereby preventing the backflow of air into a distance formed between the fan and the fan housing.

The fan includes a hub to which a rotation shaft of the fan motor is coupled; a shroud spaced apart from the hub; and a plurality of blades disposed between the hub and the shroud, wherein the cover is disposed in an outer direction of the shroud, so as not to interfere with the rotation of the fan.

A distance by which the fan inlet is horizontally spaced apart from the shroud is formed to be larger than or equal to a distance by which the cover is horizontally spaced apart from the shroud, thereby minimizing the air flow to the distance formed between the fan and the fan housing.

The fan inlet includes a curved portion bent upward from an inner end portion of the lower wall, and a straight portion extending upwardly from an end portion of the curved portion.

A distance by which a lower end of the curved portion is vertically spaced apart from the shroud is formed to be larger than a distance by which an upper end of the curved portion is horizontally spaced apart from the shroud, thereby minimizing the air flow to the distance formed between the fan and the fan housing.

A horizontal hole spaced in a horizontal direction and a vertical hole spaced in a vertical direction are formed between the shroud and the fan inlet, wherein a distance of the vertical holes is formed larger than a distance of the horizontal hole, thereby minimizing friction due to vertical vibration caused by rotation of the fan.

The air shroud includes a lower protruding portion having a shroud suction port through which air passed through the fan inlet is sucked; and a second blade coupling portion extending upward from the lower protruding portion.

The cover includes an inner wall disposed toward a center of the fan housing; an outer wall facing in a direction opposite to the inner wall; and an upper wall connecting an upper end of the inner wall and an upper end of the outer wall, wherein the inner wall is disposed to face the outer wall of the shroud.

The inner wall includes an inner upper wall which is spaced apart from the fan inlet in a horizontal direction and forms a straight surface; and an inner lower wall which is disposed in a lower portion of the inner upper wall, and bent toward a center of rotation shaft of the fan, wherein the inner lower wall is formed in a lower position than the fan inlet.

A protrusion protruding in a direction facing each other is disposed in the inner wall of the cover or in the outer wall of the shroud disposed opposite to the inner wall, thereby minimizing the air flow to the distance formed between the fan and the fan housing.

The protrusion has a threaded shape, or has a rectangular shape.

A first protrusion protruding toward the outer wall of the shroud is formed in the inner wall of the cover, and a second protrusion protruding toward the inner wall is formed in the outer wall of the shroud, thereby minimizing the air flow to the distance formed between the fan and the fan housing.

The first protrusion and the second protrusion are spaced apart from each other in a vertical direction.

### BRIEF DESCRIPTION OF THE DRAWINGS

The above and other objects, features and advantages of the present disclosure will be more apparent from the following detailed description in conjunction with the accompanying drawings, in which:

FIG. 1 is a perspective view of an air purifier according to a first embodiment of the present disclosure;

FIG. 2 is a schematic cross-sectional view of an air purifier according to a first embodiment of the present disclosure;

FIG. 3 is a cross-sectional view of a fan and a fan housing according to a first embodiment of the present disclosure;

FIG. 4 is an enlarged view of A of FIG. 3; and

FIGS. 5A to 5F are diagrams showing a relationship between a fan and a cover according to another embodiment of the present disclosure.

### DETAILED DESCRIPTION OF THE PREFERRED EMBODIMENTS

Advantages and features of the present disclosure and methods for achieving them will be made clear from the embodiments described below in detail with reference to the accompanying drawings. The present disclosure may, however, be embodied in many different forms and should not be construed as being limited to the embodiments set forth herein. Rather, these embodiments are provided so that this disclosure will be thorough and complete, and will fully convey the scope of the invention to those skilled in the art. The present disclosure is defined only by the scope of the claims. Like reference numerals refer to like elements throughout the specification.

Hereinafter, referring to the accompanying drawings, a preferred embodiment of the present disclosure is described as follows.

Hereinafter, the present disclosure will be described with reference to the drawings for explaining an air purifier according to embodiments of the present disclosure.

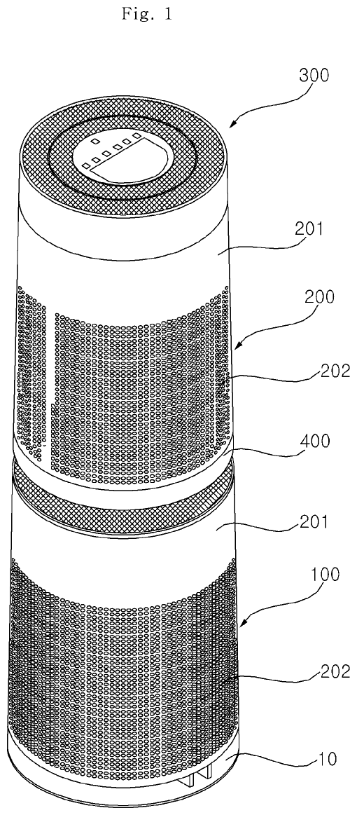

Referring to FIG. 1, an air purifier 10 according to an embodiment of the present disclosure includes a blowing device 100, 200 for generating air flow and a flow conversion device for switching the discharge direction of the air flow generated by the blowing device 100, 200. The blowing device 100, 200 includes a first blowing device 100 for generating a first air flow and a second blowing device 200 for generating a second air flow.

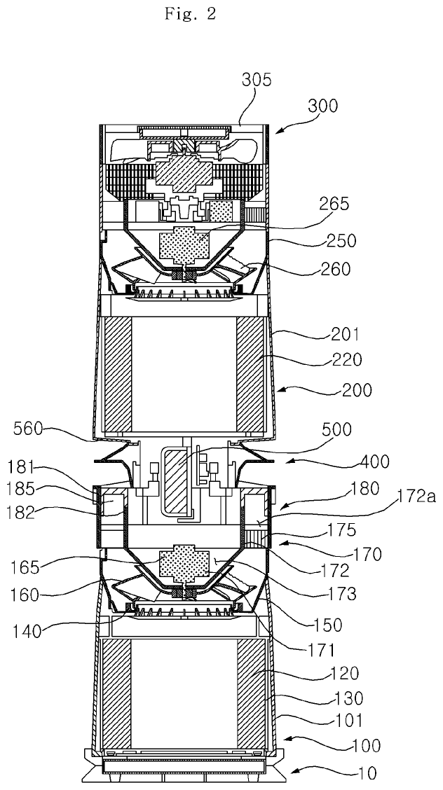

Referring to FIGS. 1 to 2, the first blowing device 100 and the second blowing device 200 may be disposed in a vertical direction. The second blowing device 200 may be disposed above the first blowing device 100. In this case, a first air flow forms a flow that sucks indoor air existing in the lower side of the air purifier 10, and a second air flow forms a flow that sucks indoor air existing in the upper wall of the air purifier 10.

The air purifier 10 includes a case 101 and 201 forming an outer shape. The case 101, 201 include a first case 101 forming an outer shape of the first blowing device 100 and a second case 201 forming an outer shape of the second blowing device 200.

The first case 101 may have a cylindrical shape. The upper portion of the first case 101 may be configured to have a smaller diameter than the lower portion.

In the first case 101, a first suction port 102 through which air is sucked is formed. The first suction port 102 communicates the inner side and the outer side of the first case 101. A plurality of first suction ports 102 are formed.

The plurality of first suction ports 102 are formed evenly in the circumferential direction along the outer peripheral surface of the first case 101 so that air can be sucked in any direction based on the first case 101. Referring to FIG. 1, air may be sucked in a 360-degree direction based on a center line in the vertical direction passing through the inner center of the first case 101.

As described above, the first case 101 is configured in a cylindrical shape, and a plurality of first suction ports 102 are formed along the outer peripheral surface of the first case 101, so that the amount of air sucked may be increased.

The first blowing device 100 further includes a base 20 provided below the first case 101 and disposed on the ground. The base 20 is positioned to be spaced downward from the lower end of the first case 101. In a separate space between the first case 101 and the base 20, a base suction part 103 is formed.

A first discharge part 105 is formed in the upper portion of the first blowing device 100. Air discharged through the first discharge part 105 may flow upward in the shaft direction.

The second case 201 may have a cylindrical shape. In addition, the upper portion of the second case 201 may be configured to have a smaller diameter than the lower portion. In the second case 201, a second suction port 202 through which air is sucked is formed. The second suction port 202 includes a through hole formed by penetrating at least a portion of the second case 201. A plurality of second suction ports 202 are formed.

The plurality of second suction ports 202 are formed evenly in the circumferential direction along the outer peripheral surface of the second case 201 so that air can be sucked in any direction based on the second case 201. That is, air may be sucked in a 360-degree direction, based on a center line in the vertical direction passing through the inner center of the second case 201.

A first filter 120 may have a cylindrical shape having an open top. The first blowing device 100 further includes a first filter frame 130 forming a mounting space for the first filter 120.

In the mounting space, the first filter 120 may be detachably mounted. The first filter 120 has a cylindrical shape, and air may be introduced through the outer peripheral surface of the first filter 120. In the process of passing through the first filter 120, impurities such as fine dust in the air may be filtered out.

Since the first filter 120 has a cylindrical shape, air can be introduced from any direction based on the first filter 120. Accordingly, the filtering area of the air may be increased.

The mounting space may be provided in a cylindrical shape corresponding to the shape of the first filter 120. The first filter 120 may be slidably inserted toward the mounting space during the mounting process. On the other hand, the first filter 120 may be slidably extracted from the mounting space during the separation process.

In addition, in the second blowing device 200, a second filter 220 is disposed in a second filter frame 230, and may be explained in the same manner as described in the first filter 120 and the first filter frame 130 described above.

Each of the first blowing device 100 and the second blowing device 200 includes a fan housing 150, 250 installed in the outlet side of the filter 120, 220, a fan 160, 260 rotatably disposed inside the fan housing 150, 250, and a fan motor 165, 265 that rotates the fan 160, 260.

Each of the first blowing device 100 and the second blowing device 200 further includes a cover 140, 240 which is disposed between the fan 160, 260 and the fan housing 150, 250, and prevents the reverse flow of air.

The configuration and disposition of the fan 160, 260, the fan housing 150, 250, and the cover 140, 240 will be described in detail below.

The first blowing device 100 further includes a first air guide device 170 which is coupled to an upper wall of the first fan 160 and guides the flow of air passed through the first fan 160.

The first air guide device 170 includes an outer wall 171 having a cylindrical shape and an inner wall 172 positioned inside the outer wall 171 and having a cylindrical shape. The outer wall 171 is disposed to surround the inner wall 172. A first air flow path 172a through which air flows is formed between the inner peripheral surface of the outer wall 171 and the outer peripheral surface of the inner wall 172.

The first air guide device 170 includes a guide rib 175 disposed in the first air flow path 172a. The guide rib 175 extends from the outer peripheral surface of the inner wall 172 to the inner peripheral surface of the outer wall 171. A plurality of guide ribs 175 may be spaced apart from each other. The plurality of guide ribs 175 serves to guide the air introduced into the first air flow path 172a of the first air guide device 170 through the first fan 160 upward.

The first air guide device 170 further includes a motor accommodating part 173 that extends downward from the inner wall 172 and accommodates the first fan motor 165. The motor accommodating part 173 may have a bowl shape whose diameter decreases toward the bottom. The shape of the motor accommodating part 173 may correspond to the shape of a hub 161. The motor accommodating part 173 may be inserted into the hub 161.

The first fan motor 165 may be supported on the upper wall of the motor accommodating part 173. In addition, a rotation shaft 165a of the first fan motor 165 extends downward from the first fan motor 165, penetrates through the bottom surface of the motor accommodating part 173, and may be coupled with a shaft coupling part 161a of the hub 161.

A motor coupling part 166 is provided above the first fan motor 165. The motor coupling part 166 guides the first fan motor 165 to be fixed to the first air guide device 170.

The first blowing device 100 further includes a second air guide device 180 which is coupled to the upper wall of the first air guide device 170 and guides the air that passed through the first air guide device 170 to a first discharge guide device 190.

The second air guide device 180 includes a first guide wall 181 having a substantially cylindrical shape, and a second guide wall 182 positioned inside the first guide wall 181 and having a substantially cylindrical shape. The first guide wall 181 may be disposed to surround the second guide wall 182.

The first air guide device 170 and the second air guide device 180 described above may be identically applied to a second blowing device 200.

A second air flow path 185 through which air flows is formed between the inner peripheral surface of the first guide wall 181 and the outer peripheral surface of the second guide wall 182. In addition, the first discharge part 105 is disposed above the second air flow path 185.

The first discharge part 105 may have a grill shape so that air may be discharged to the outside.

The air purifier 10 includes a partitioning device 400 provided between the first blowing device 100 and the second blowing device 200. By means of the partitioning device 400, the second blowing device 200 may be positioned to be spaced apart above the first blowing device 100.

The flow conversion device may be installed above the second blowing device 200. Based on the air flow, the air flow path of the second blowing device 200 may be in communication with the air flow path of the flow conversion device. The air that passed through the second blowing device 200 passes through the air flow path of the flow conversion device 300 and may be discharged to the outside through a second discharge part 305. The second discharge part 305 is formed at the upper end of the flow conversion device 300.

The flow conversion device 300 may be provided to be movable. As shown in FIG. 1, the flow conversion device 300 may be in a lying state or in an obliquely erect state (a second position, not shown).

In addition, a display device 600 that displays operation information of the air purifier 10 is provided above the flow conversion device 300. The display device 600 may move together with the flow conversion device 300.

The first blowing device 100 includes a base 20 and a suction grill 110 disposed above the base 20. A base suction part 103 that forms a suction space for air is formed between the base 20 and the suction grill 110.

The air sucked through the base suction part 103 may pass through the first filter 120. The first filter 120 is provided in a cylindrical shape and may have a filter surface for filtering air.

The second blowing device further includes a lever support device 560 that supports a second filter 220 of the second blowing device 200. The lever support device 560 has a substantially annular shape. Inside the lever support device 560, a PCB device 500 may be disposed.

The lever support device 560 has an annular shape and extends slightly inclined upward with respect to the shaft direction from the inner peripheral surface toward the outer peripheral surface.

The lever support device 560 may block the air discharged through the first discharge part 105 of the first blowing device 100 from flowing into the second blowing device 200.

A partition device 400 is provided between the first blowing device 100 and the second blowing device 200. The partition device 400 includes a partition plate 430 for separating or blocking the air flow generated by the first blowing device 100 and the air flow generated by the second blowing device 200. By the partition plate 430, the first and second blowing devices 100 and 200 may be disposed to be spaced apart in the vertical direction.

That is, a separate space in which the partition plate 430 is positioned is formed between the first blowing device 100 and the second blowing device 200. The first discharge guide device 190 of the first blowing device 100 may be positioned in a lower end of the separate space, and the lever support device 560 of the second blowing device 200 may be positioned in an upper end of the separate space.

The second filter 220 is disposed inside the second blowing device 200. The second filter 220 has a shape similar to that of the first filter 120 described above, and may perform the same function.

The second blowing device 200 includes a second fan 260 which is disposed above the second filter 220 and forms a flow of air, a second fan motor 265 that rotates the second fan 260, and a second fan housing 250 in which the second fan 260 is disposed. The second fan 260, the second fan motor 265, and the second fan housing 250 have the same configuration as and a similar shape to the first fan 160, the first fan motor 165, and the first fan housing 150 described above, and may perform the same function.

<Blowing Fan, Ventilation Housing, Cover>

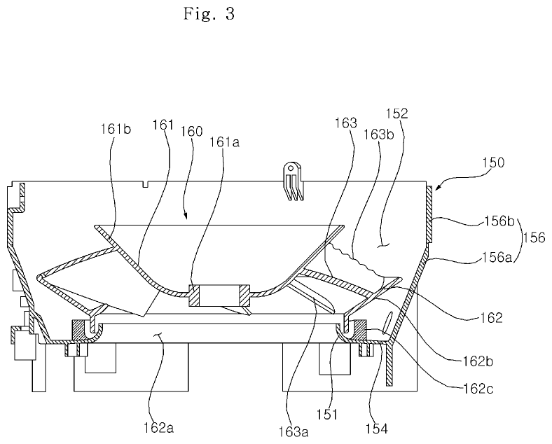

Hereinafter, with reference to FIG. 3, the configuration and disposition relationship of each of the fan, the fan housing, and the cover of the present disclosure will be described.

Each of the first blowing device 100 and the second blowing device 200 includes a cover 140, 240 which is disposed between the fan 160, 260 and the fan housing 15, 250, and prevents the backflow occurring between the fan 160, 260 and the fan housing 15, 250.

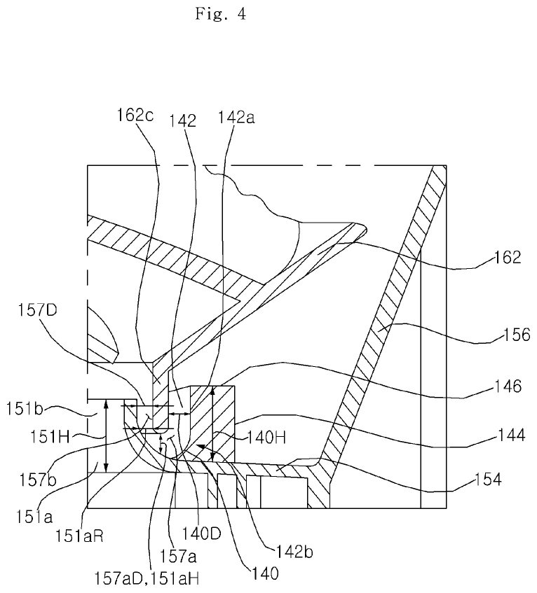

The fan 160, the fan housing 150, and the cover 140 described in FIGS. 3 to 4 use the same reference numeral as the first fan 160, the first fan housing 150, and the first cover 140 included in the first blowing device 100. The fan 160, the fan housing 150, the cover 140 and their respective specific configurations described in FIGS. 3 to 4 may be applied to each of the second fan 260, the second fan housing 250, and the second cover 240 included in the second blowing device 200.

In the fan housing 150, a housing space portion 152 in which the fan 160 is accommodated is formed. The fan housing 150 may be supported by the filter frame 130. A fan inlet 151 that guides the inflow of air to the fan housing 150 is included in the lower portion of the fan housing 150. A grill is disposed in the fan inlet 151.

The fan housing 150 has a hollow inside and an open upper wall. The fan housing 150 has a housing suction hole 154a opened in the vertical direction formed in the center of a lower wall 154.

The fan housing 150 includes a circumferential wall 156 that is spaced outside the circumference of the fan 160 and forms a space in which the fan 160 is accommodated, a lower wall 154 that is bent at the lower end of a circumferential wall 156 and extends in the direction of the rotational center of the fan 160, and a fan inlet 151 that is bent upward from the inner end of the lower wall 154 and extends.

A part of the circumferential wall 156 may be disposed inside the case 101. A portion of the circumferential wall 156 may be disposed in the upper wall of the case 101. The circumferential wall 156 includes a lower circumferential wall 156a disposed inside the case 101 and an upper circumferential wall 156b that is disposed above the lower circumferential wall 156a and disposed in the upper wall of the case 101. The lower circumferential wall 156a may have a shape whose radius increases toward an upward direction.

The lower wall 154 may have a ring shape in which a housing suction hole 154a is formed in the center. In the inner end of the lower wall 154, a fan inlet 151 that is bent upward and extends is formed.

The fan inlet 151 may be formed from a lower side where a lower protruding portion 162c of a shroud 162 described below is disposed. The fan inlet 151 may have a shape whose radius decreases from the lower wall 154 toward the upper wall. The fan inlet 151 forms a convex curved surface in the lower center direction in which the filter 120 is disposed. The fan inlet 151 may include a curved portion 151a that is bent upward from an inner end of the lower wall 154 and a straight portion 151b that extends upward from an end of the curved portion 151a.

A distance 151aH by which the lower end of the curved portion 151a is spaced apart from the shroud 162 in the vertical direction is larger than a distance 151aR by which the upper end of the curved portion 151a is spaced apart from the shroud 162 in the horizontal direction. The fan 160 is spaced apart from the fan housing 150 for free rotation.

A separation hole 157a, 157b is formed between the shroud 162 of the fan 160 and the fan inlet 151 of the fan housing 150. Between the shroud 162 of the fan 160 and the fan inlet 151 of the fan housing 150, a horizontal hole 157b spaced in a horizontal direction and a vertical hole 157a spaced in a vertical direction are formed. A distance 157aD of the vertical holes 157a is formed larger than a distance 157bD of the horizontal holes 157b.

Here, the vertical direction may mean a vertical direction in which the blowing devices 100 and 200 are stacked, and the horizontal direction may mean a radial direction perpendicular to the rotational direction of the fan 160.

The straight portion 151b is formed upward at the same height as the lower end of the shroud 162. Accordingly, the straight portion 151b is spaced apart from each other at the same distance as the shroud 162 facing each other. The curved portion 151a is disposed below the shroud 162.

The fan 160 is disposed above the fan inlet 151. The fan 160 includes a centrifugal fan that introduces air in the shaft direction and discharges the air upward in the radial direction.

The fan 160 includes a hub 161 to which the rotation shaft 165a of the fan motor 165, which is a centrifugal fan motor, is coupled, a shroud 162 disposed spaced apart from the hub 161, and a plurality of blades 163 disposed between the hub 161 and the shroud 162. The fan motor 165 may be coupled to the upper wall of the fan 160.

The hub 161 may have a bowl shape whose diameter becomes narrower as it progresses downward. The hub 161 includes a shaft coupling portion 161a to which the rotation shaft 165a is coupled and a blade coupling portion 161b extending obliquely upward from the shaft coupling portion.

The shroud 162 includes a lower protruding portion 162c having a shroud suction port 162a through which air passed through the fan inlet 151 is sucked, and a second blade coupling portion 162b extending upward from the lower end.

The shroud 162 is spaced apart from the hub 161 to form a surface substantially parallel to the hub 161. The lower end of the shroud 162 has a lower protruding portion 162c protruding downward from the lower end of the second blade coupling portion 162b.

The shroud 162 includes a blade coupling portion 161b forming a surface substantially parallel to the hub 161, and a lower protruding portion 162c bent in the lower end of the blade coupling portion 161b and protruding downward. The lower protruding portion 162c may be spaced apart from the fan inlet 151 of the fan housing 150 by a certain distance.

One surface of the blade 163 may be coupled to the blade coupling portion 161b of the hub 161, and the other surface may be coupled to the second blade coupling portion 162b of the shroud 162. In addition, a plurality of blades 163 may be disposed to be spaced apart in the circumferential direction of the hub 161.

The blade 163 includes a leading edge 163a forming a side end portion through which air is introduced and a trailing edge 163b forming a side end portion through which air is discharged.

The air that passed through the filter 120 flows upward and flows into the fan housing 150 through the fan inlet 151. In addition, the air flows in the shaft direction of the fan 160, flows into the leading edge 163a, and is discharged to the trailing edge 163b through the blade 163.

In this case, the trailing edge 163b may extend inclined upwardly outward with respect to the shaft direction in correspondence with the flow direction of the air so that the air discharged through the trailing edge 163b may flow upward in the radial direction.

The cover 140 is spaced apart in the outer direction of the shroud 162, and is formed to protrude upward from the lower wall 154 of the fan housing 150. The cover 140 may have a ring shape.

A height 140H by which the cover 140 protrudes upward to the lower wall 154 of the fan housing 150 is formed longer than a height 151H by which the fan inlet 151 of the fan housing 150 protrudes upward from the lower wall 154 of the fan housing 150.

A distance 140D by which the cover 140 is horizontally spaced apart from the shroud 162 is formed less than or equal to a distance 151D by which the fan inlet 151 of the fan housing 150 is spaced apart from the shroud 162 in the horizontal direction.

The cover 140 includes an inner wall 142 disposed to face the center of the fan housing 150, an outer wall 144 facing the opposite direction to the inner wall 142, and an upper surface 146 connecting the upper end of the inner wall 142 and the upper end of the outer wall 144.

The inner wall 142 includes an inner upper wall 142a which is disposed horizontally spaced apart from the fan inlet 151 of the shroud 162 and forms a straight surface, and an inner lower wall 142b which is disposed below the inner upper wall 142a and bent toward the center of the fan housing 150. The inner lower wall 142b is formed at a position lower than the fan inlet 151 of the shroud 162.

A space by which the inner upper wall 142a and the fan inlet 151 of the shroud 162 are horizontally spaced is formed smaller than a distance 151D by which the fan inlet 151 of the shroud 162 and the fan housing 150 are vertically spaced.

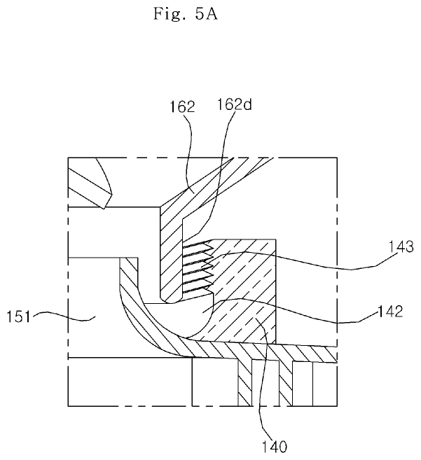

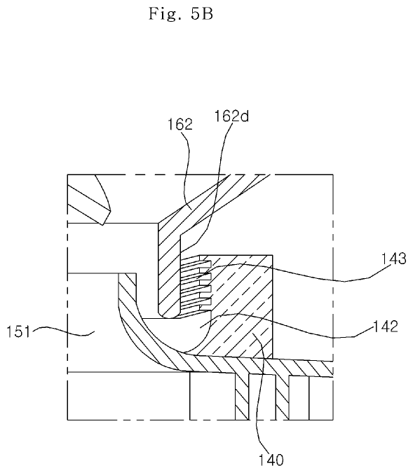

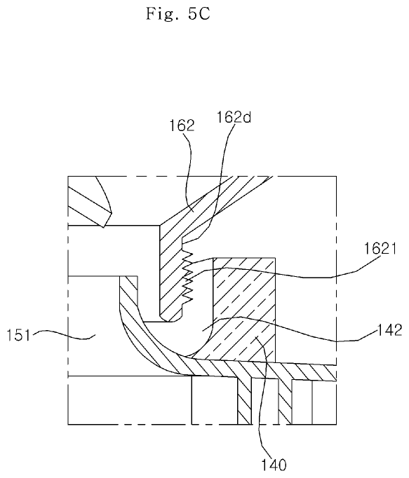

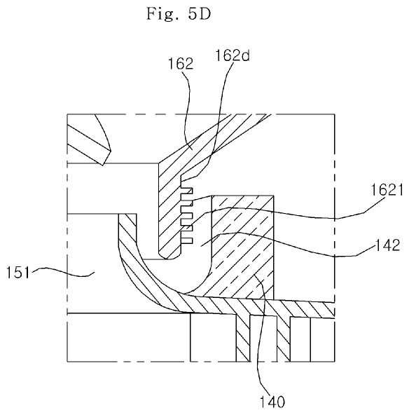

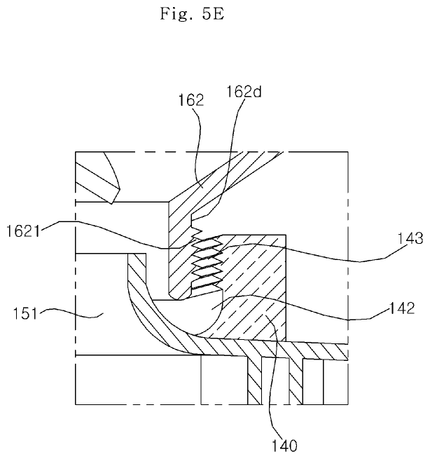

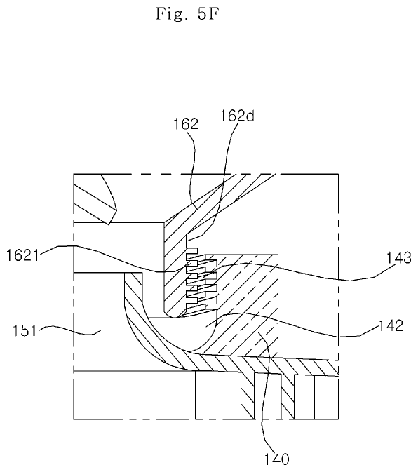

Hereinafter, various modified embodiments of the shroud 162 and the cover 140 will be described with reference to FIGS. 5A to 5F.

The inner wall 142 of the cover 140 or the outer wall 162d of the shroud 162 disposed opposite to the inner wall 142 of the cover 140 may include a protrusion 143, 1621 protruding in a direction facing each other.

That is, as shown in FIGS. 5A and 5B, a protrusion 143 protruding in the direction of the outer wall 162d of the lower protruding portion 162c of the shroud 162 from the inner wall 142 of the cover 140 may be formed, or as shown in FIGS. 5C and 5D, a protrusion 1621 protruding in the direction of the inner wall 142 of the cover 140 from the outer wall 162d of the lower protruding portion 162c of the shroud 162 may be formed. In addition, as shown in FIGS. 5E and 5F, the first protrusion 143 protruding in the direction of the outer wall 162d of the lower protruding portion 162c of the shroud 162 from the inner wall 142 of the cover 140 may be formed, or the second protrusion 1621 protruding in the direction of the inner wall 142 of the cover 140 from the outer wall 162d of the lower protruding portion 162c of the shroud 162 may be formed.

The shape of the protrusion may have a threaded shape as shown in FIGS. 5A, 5C, and 5E, or may have a rectangular shape as shown in FIGS. 5B, 5D, and 5F. The protrusion narrows a distance between the outer wall 162d of the lower protruding portion 162c of the shroud 162 and the inner wall of the cover 140, thereby preventing the backflow flowing into the separation hole 157a formed between the fan housing 150 and the fan 160.

As shown in FIGS. 5E and 5F, the first protrusion 143 disposed in the inner wall 142 of the cover 140 is disposed spaced apart from the second protrusion 1621 in the vertical direction in each of the outer wall 162d of the lower protruding portion 162c of the shroud 162. The first protrusion 143 and the second protrusion 1621 are spaced apart from each other in the vertical direction, so that friction between the fan 160 and the cover 140 due to rotation or vibration of the fan 160 can be minimized.

According to the air purifier of the present disclosure, one or more of the following effects are provided.

First, there is an advantage of maximizing the amount of air blown by the fan, by disposing a cover that covers the separation hole formed between the fan and the fan housing.

Second, the cover has the advantage of increasing the amount of air blown by the fan, by suppressing the reverse flow of air, as a plurality of protrusions are formed at a portion disposed to face the fan.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air purifier comprising:
a case having a cylindrical shape and having a plurality of air suction ports formed in a circumferential wall;
a filter disposed inside the case and filtering foreign matter in an air introduced through the air suction port;
a fan disposed above the filter and flowing the air introduced through the air suction port in an upward direction;
a fan housing disposed above the filter and forming a fan space in which the fan is disposed;
a fan motor disposed above the fan and rotating the fan; and
a cover protruding from the fan housing into the fan space so as to be disposed outside the fan,
wherein a lower end of the fan is spaced apart from a lower wall of the fan housing to an upper wall, and
the cover protrudes above the lower end of the fan from the lower wall of the fan housing.

2. The air purifier of claim 1, wherein the fan housing comprises a fan inlet that is bent to the inside of the fan and extends upward,
wherein a height of the cover protruding upward from the lower wall is higher than a height of the fan inlet protruding upward from the lower wall.

3. The air purifier of claim 1, wherein the fan housing comprises:
a circumferential wall forming a space in which the fan is accommodated;
a lower wall bent at a lower end of the circumferential wall and extending in a direction of a rotational center of the fan; and
a fan inlet upwardly bent at an inner end of the lower wall and extending,
wherein the cover is spaced radially outward from the fan inlet and is formed to protrude upward from the lower wall.

4. The air purifier of claim 3, wherein the lower end of the fan is disposed between the cover and the fan inlet.

5. The air purifier of claim 3, wherein the fan comprises:
a hub to which a rotation shaft of the fan motor is coupled;
a shroud spaced apart from the hub; and
a plurality of blades disposed between the hub and the shroud,
wherein the cover is disposed in an outer direction of the shroud.

6. The air purifier of claim 5, wherein a distance by which the fan inlet is horizontally spaced apart from the shroud is formed to be larger than or equal to a distance by which the cover is horizontally spaced apart from the shroud.

7. The air purifier of claim 5, wherein the fan inlet comprises:
a curved portion bent upward from an inner end portion of the lower wall; and
a straight portion extending upwardly from an end portion of the curved portion.

8. The air purifier of claim 7, wherein a distance by which a lower end of the curved portion is vertically spaced apart from the shroud is formed to be larger than a distance by which an upper end of the curved portion is horizontally spaced apart from the shroud.

9. The air purifier of claim 5, wherein a horizontal hole spaced in a horizontal direction and a vertical hole spaced in a vertical direction are formed between the shroud and the fan inlet,
wherein a distance of the vertical holes is formed larger than a distance of the horizontal hole.

10. The air purifier of claim 5, wherein the shroud comprises:
a lower protruding portion having a shroud suction port through which air passed through the fan inlet is sucked; and
a second blade coupling portion extending upward from the lower protruding portion.

11. The air purifier of claim 5, wherein the cover comprises:
an inner wall disposed toward a center of the fan housing;
an outer wall facing in a direction opposite to the inner wall; and
an upper wall connecting an upper end of the inner wall and an upper end of the outer wall,
wherein the inner wall is disposed to face the outer wall of the shroud.

12. The air purifier of claim 11, wherein the inner wall comprises:
an inner upper wall which is spaced apart from the fan inlet in a horizontal direction and forms a straight surface; and
an inner lower wall which is disposed in a lower portion of the inner upper wall, and bent toward a center of rotation shaft of the fan,
wherein the inner lower wall is formed in a lower position than the fan inlet.

13. The air purifier of claim 11, wherein a protrusion protruding in a direction facing each other is disposed in the inner wall of the cover or in the outer wall of the shroud disposed opposite to the inner wall.

14. The air purifier of claim 13, wherein the protrusion has a threaded shape.

15. The air purifier of claim 13, wherein the protrusion has a rectangular shape.

16. The air purifier of claim 11, wherein a first protrusion protruding toward the outer wall of the shroud is formed in the inner wall of the cover, and a second protrusion protruding toward the inner wall is formed in the outer wall of the shroud.

17. The air purifier of claim 16, wherein the first protrusion and the second protrusion are spaced apart from each other in a vertical direction.
